(19) United States
(12) Patent Application Publication
(10) Pub. No.: US 2002/0083717 A1
(43) Pub. Date: Jul. 4, 2002

(54) Containment system for samples of dangerous goods stored at cryogenic temperatures

(76) Inventors: Patrick L. Mullens, St. Covina, CA (US); Gregg Emmel, Marina Del Rey, CA (US); Kevin Glesy, Chino Hills, CA (US); Christy Thomas, Marina Del Rey, CA (US)

Correspondence Address: Roy L. Anderson, Esq., Jeffers, Shaff & Falk, LLP, Suite 1400, 18881 Von Karman Ave., Irvine, CA, 92612, US

(21) Appl. No.: 09/753,207

(22) Filed: Dec. 29, 2000

(51) Int. Cl. F17C 11/00; F25B 19/00

(52) U.S. Cl. 62/46.1; 62/51.1

(57) ABSTRACT

A containment system for samples of dangerous goods stored at cryogenic temperatures includes a bag made of a cryogenically compatible polymer film and a porous structural cartridge made of a polypropylene polymer compound for holding a plurality of sample receptacles separate from one another to comply with the standards of UN Class 6.2 certification. The porous structural cartridge has a cartridge base with a plurality of sample receptacle apertures for holding the plurality of sample receptacles. A cartridge cover mates with the cartridge base to enclose the plurality of sample receptacle apertures. Additional cartridge bases can be included as part of the porous structural cartridge. Each cartridge has sufficient absorbing capacity to absorb the entire contents of all of the sample receptacles held within its sample receptacle apertures. The bag can be a polyimide film or a fluorinated ethylene propylene resin that meets American Society for Testing and Materials Standard Specification D2116-97 for FEP-Fluorocarbon Molding and Extrusion Materials. Specific examples of especially useful polymer films include Kapton® polyimide film and Teflon® FEP. The bag has a sealing mechanism that will seal the bag when it is actuated. The sealing mechanism can be a mechanical closure constructed of two materials with dissimilar coefficients of thermal expansion, an adhesive joint or a heat seal.

### CROSS REFERENCE TO RELATED APPLICATIONS

The present application is related to the following three patent applications, all of which are specifically incorporated herein by reference, and all of which are being filed concurrently with the present application on the same date: Attorney Docket No. JSF35.051, entitled “CRYOGENIC SHIPPING CONTAINER,” Attorney Docket No. JSF35.052, entitled “SELF-VENTING CAP FOR A NECK OF A DEWAR VESSEL,” and Attorney Docket No. JSF35.053, entitled “SPECIMEN CHAMBER FOR A CRYOGENIC SHIPPING CONTAINER.”

### FIELD OF THE INVENTION

The present invention is in the field of containment systems for use in shipping samples of dangerous materials in cryogenic shipping containers.

### BACKGROUND OF THE INVENTION

To ensure reproducible results in research and biotechnical processes, today's scientists and clinical practitioners have found it necessary to genetically stabilize living cells and preserve the integrity of complex molecules for storage and transport. This is accomplished by containing these materials in enclosures where cryogenic temperatures are continuously maintained at or near liquid nitrogen or vapor phase liquid nitrogen temperatures (77K and 100K, respectively).

Advances in cryopreservation technology have led to methods that allow low-temperature maintenance of a variety of cell types and molecules. Techniques are available for the cryopreservation of cultures of viruses and bacteria, isolated tissue cells in tissue culture, small multi-cellular organisms, enzymes, human and animal DNA, pharmaceuticals including vaccines, diagnostic chemical substrates, and more complex organisms such as embryos, unfertilized oocytes, and spermatozoa. These biological products must be transported or shipped in a frozen state at cryogenic temperatures to maintain viability. This requires a shipping enclosure that can maintain a cryogenic environment for up to 10 days and meet other shipping requirements such as being relatively impervious to mechanical shock and effects of directional orientation.

In addition to the already existing difficulties posed in shipping heat-sensitive biologicals, the International Air Transport Association (IATA) imposed new regulations which became effective in January 1995 pertaining to all shipments that include specimens containing infectious agents or potentially infectious agents. These regulations, endorsed by the US Department of Transportation (DOT) and applicable to all public and private air, sea, and ground carriers, imposed greatly increased requirements upon shipping units to survive extensive physical damage (drop-testing, impalement tests, pressure containment tests, vibration tests, thermal shock, and water damage) without leakage and without fracture of the internal, primary receptacles (vials). Implementation of this regulation further complicated the shipping of frozen biologicals.

Even though bioshippers are currently available using liquid nitrogen as a refrigerant, little innovation has taken place in the design of packaging for low-temperature transport. Current shippers are generally vulnerable to the physical damage and changes in orientation encountered during routine shipping procedures. Additionally, these shippers rarely comply with the IATA Dangerous Goods Regulation (effective January 1995 or as later amended). Commercial vendors have not developed or certified a cost-effective, standardized shipping unit with the necessary specimen capacity and hold time to meet user demands.

One of the main criticisms of current shippers is price, which varies from $500.00 to $1,000.00 or more per unit. This substantially limits their use for the transport of many biologicals. Because of the initial cost and limited production of these containers, they are designed to be reusable. However, the cost of return shipping of these heavy containers is significant, particularly in international markets.

Users also complain about the absorbent filler used in the current dry shippers, which breaks down with continuous use, contaminating the interior of the container. In fact, one large user of these containers has essentially centered their entire shipping operation around cleaning the broken down absorbent material from the inside of these containers after each use.

Another problem cited by users of currently available dry shippers relates to the functional hold time versus static hold time. Static hold time pertains to a fully charged shipper with no heat load, sitting upright, e.g., essentially not in use. Functional hold time refers to the fully charged shipper in use and containing samples, e.g., in the process of being handled and transported. Even though the static hold time is promoted as being 20 days, if the container is tilted or positioned on its side, the hold time diminishes to hours as opposed to days. This occurs because the liquid nitrogen transitions to the gaseous (vapor) phase more rapidly resulting in outgassing. The liquid nitrogen can also simply leak out of the container when it is positioned on its side.

The current cryogenic containers are promoted as being durable because they are of metal construction. However, rugged handling frequently results in the puncturing of the outer shell or cracking at the neck, resulting in loss of the high vacuum insulation. This renders them useless. The metal construction also adds to the weight of the container, thereby adding substantially to shipping costs.

Thus, there is a need for an improved cryogenic container that can be used to ship biologicals safely, reliably, and economically. U.S. Pat. No. 6,119,465 seeks to meet this need by using unique, lightweight, low-cost, durable composites and polymers in a semi-disposable vapor phase liquid nitrogen bioshipper. This is accomplished in an inherently simple, reliable, and inexpensive device that will result in reduced shipping costs, enhanced reliability and safety, and fewer service requirements.

The present invention builds upon the framework laid by U.S. Pat. No. 6,119,465, the disclosure of which is specifically incorporated herein by reference. This is done by disclosing an improved specimen holder for use in shipping dangerous goods in a cryogenic shipping container

### SUMMARY OF THE INVENTION

The present invention is generally directed to a containment system for samples of dangerous goods stored at cryogenic temperatures that includes a bag made of a cryogenically compatible polymer film with a sealing mechanism that will seal the bag when it is actuated and a porous structural cartridge for holding a plurality of sample receptacles separate from one another. The porous structural cartridge has a cartridge base with a plurality of sample receptacle apertures for holding the plurality of sample receptacles. A cartridge cover mates with the cartridge base to enclose the plurality of sample receptacle apertures and any sample receptacles held within said plurality of sample receptacle apertures.

In a first, separate aspect of the present invention, one or more additional cartridge bases can be included as part of the porous structural cartridge. Each such additional cartridge has its own base with additional sample receptacle apertures for holding additional sample receptacles. The additional cartridges are adapted to matingly engage with a bottom of a separate cartridge base to enclose the additional receptacle apertures and any additional sample receptacles held therein. Each additional cartridge base has sufficient absorbing capacity to absorb the entire contents of all of the additional plurality of sample receptacles held within the additional sample receptacle apertures of the particular cartridge. The cartridge base and any additional cartridge bases can form a substantially cylindrical shape when stacked together and held within the bag once the sealing mechanism is actuated.

In another, separate aspect of the present invention, the polymer film used in the bag can be a polyimide film or a fluorinated ethylene propylene resin that meets American Society for Testing and Materials Standard Specification D2116-97 for FEP-Fluorocarbon Molding and Extrusion Materials. Specific examples of especially useful polymer films include Kapton® polyimide film and Teflon® FEP. It is useful for the bag to have a handle, which can be made from a loop of the polymer film, for lowering the containment system into, and raising it from, a specimen chamber of a dewar vessel.

In still another, separate aspect of the present invention, the sealing mechanism of the bag can be a mechanical closure constructed of two materials with dissimilar coefficients of thermal expansion, an adhesive joint or a heat seal.

In yet another, separate aspect of the present invention, the structural cartridge is made of a polypropylene polymer compound and has sufficient absorbing capacity to absorb the entire contents of all of the plurality of sample receptacles held within the plurality of sample receptacle apertures. The containment system can be incorporated into a dewar vessel assembly and comply with the standards of UN Class 6.2 certification.

Accordingly, it is a primary object of the present invention to provide an improved containment system for samples of dangerous goods stored and transported at cryogenic temperatures.

This and further objects and advantages will be apparent to those skilled in the art in connection with the drawings and the detailed description of the preferred embodiment set forth below.

### BRIEF DESCRIPTION OF THE DRAWINGS

FIG. 1 is an exploded assembly drawing of a preferred embodiment of a portable, insulated shipping container according to the present invention with a containment system for dangerous materials.

FIG. 2 is a planar cross section with a partial cutaway view of a preferred embodiment of a portable, insulated shipping container.

FIG. 3 is an assembly drawing of a preferred embodiment of a dewar vessel assembly.

FIG. 4 is an exploded assembly drawing of a preferred embodiment of a self-venting cap taken from reverse directions.

FIGS. 5A-5C are a planar cross section of a preferred embodiment of a portable, insulated shipping container showing connection of a preferred self-venting cap.

FIG. 6 depicts an assembly of a preferred embodiment of a containment system.

### DETAILED DESCRIPTION OF THE PREFERRED EMBODIMENTS

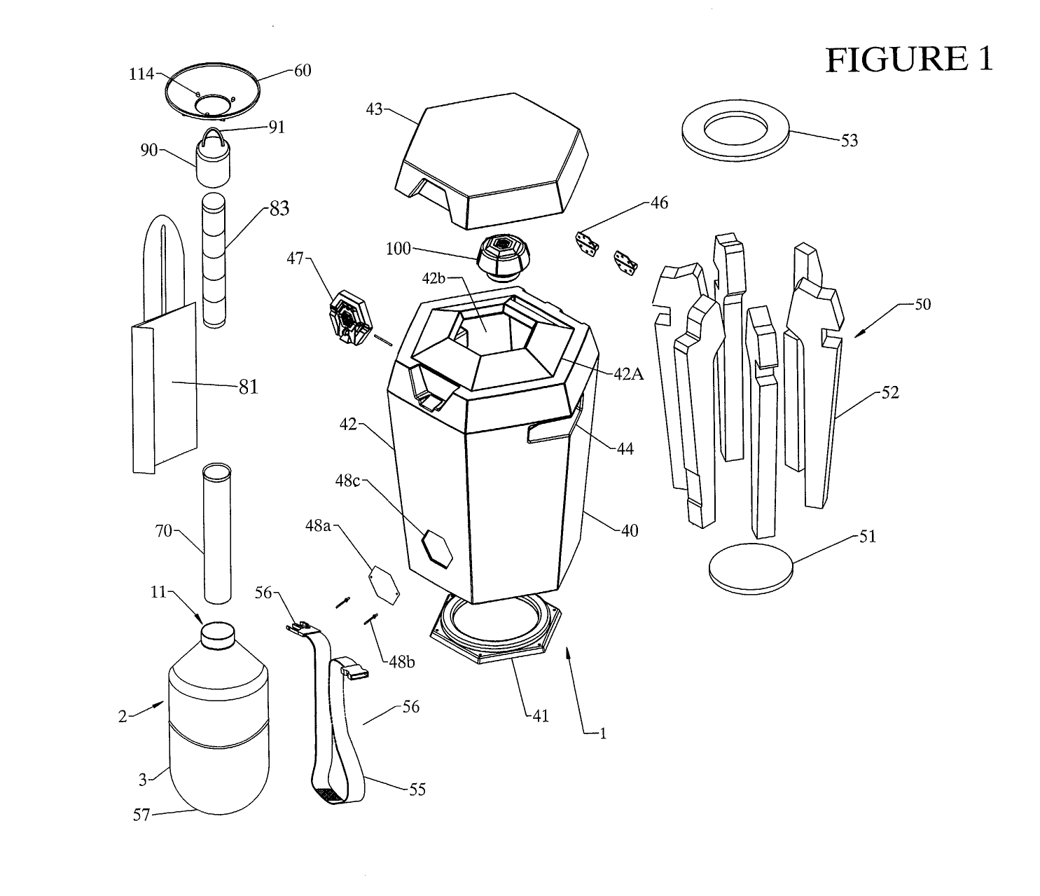

The preferred embodiments of the present invention can be used as part of an overall system that utilizes several inventions. Broadly speaking, there is an overall cryogenic shipping container system. Within the shipping container, there is a dewar vessel. Within the dewar vessel, there is a specimen chamber for holding specimens. And, in certain applications, such as shipping of dangerous goods, the specimens are held within a containment system. Although FIGS. 1-6 are described in greater detail below, the following is a glossary of the elements identified in the Figures:

1 portable, insulated shipping container

2 dewar vessel

3 outer casing of dewar vessel 2

3a upper half of outer casing 3

3b bottom half of outer casing 3

4 opening at top of outer casing 3

5 evacuable space between outer casing 3 and inner casing 13

6 getter pack

7 desiccant

8 nipple

9 layer of super insulation

10 dewar opening into inner vessel 13

11 inner vessel of dewar vessel 2

13a upper half of inner vessel 13

13b lower half of inner vessel 13

14 opening at top of inner vessel 13

15 inner wall of inner vessel 13

21 neck portion of dewar vessel 2

30 plastic foam

31 foam segment of plastic foam 30

32 capillarity separation layer of foam 30

40 outer shipping container shell

41 base of outer shipping container shell 40

42 side wall of outer shipping container shell 40

42a top side wall of side wall 42

42b top opening formed in top side wall 42a

43 top wall of outer shipping container shell 40

44 handle molded in outer shipping container shell 40

45 pocket for paperwork formed in outer shipping container shell 40

46 hinge mechanism

47 latch mechanism

48 certification plate assembly

48a certification plate

48b rivet for certification plate assembly 48

48c indentation in outer shipping container shell 40 for certification plate

50 support assembly for dewar vessel 2

51 bottom portion of support assembly 50

52 side rib portion of support assembly 50

53 top portion of support assembly 50

55 safety strap

56 adjustable buckle of safety strap 55

57 outer bottom of dewar vessel 2

60 funnel-shaped vessel plate

61 support for plate 60

62 spray foam

70 specimen chamber

71 side wall of specimen chamber 70

72 base of specimen chamber 70

73 top opening of specimen chamber 70

80 containment system

81 bag of containment system 80

82 handle of containment system 80

83 porous structural cartridge of containment system 80

84 sample receptacle of containment system 80

85 cartridge base of containment system 80

86 sample receptacle apertures of containment system 80

87 cartridge cover of containment system 80

88 additional cartridge base of containment system 80

90 inner plug

91 handle of inner plug 90

100 self-venting cap

101 lower component of self-venting cap 100

102 upper component of self-venting cap 100

102a lower surface of upper component 102

103 seal of self-venting cap 100

104 third component of self-venting cap 100

105 plate

106 screw (threads not shown)

107 cover plate

108 female thread in lower component 101

111 male thread

112 female thread

113 positioning device

114 second positioning device

115 rib

121 first plurality of apertures in lower component 101

122 second plurality of apertures in upper component 102

131 first chamber of self-venting cap 100

132 second chamber of self-venting cap 100

133 vent opening of self-venting cap 100

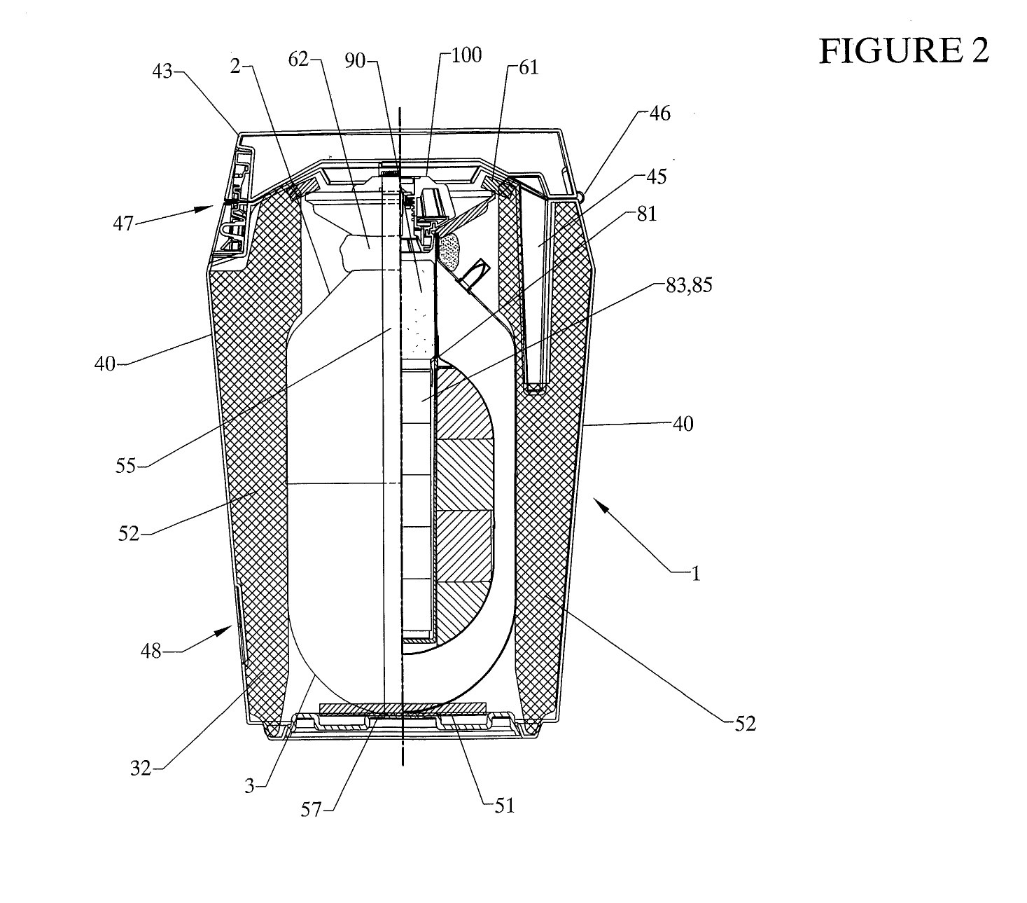

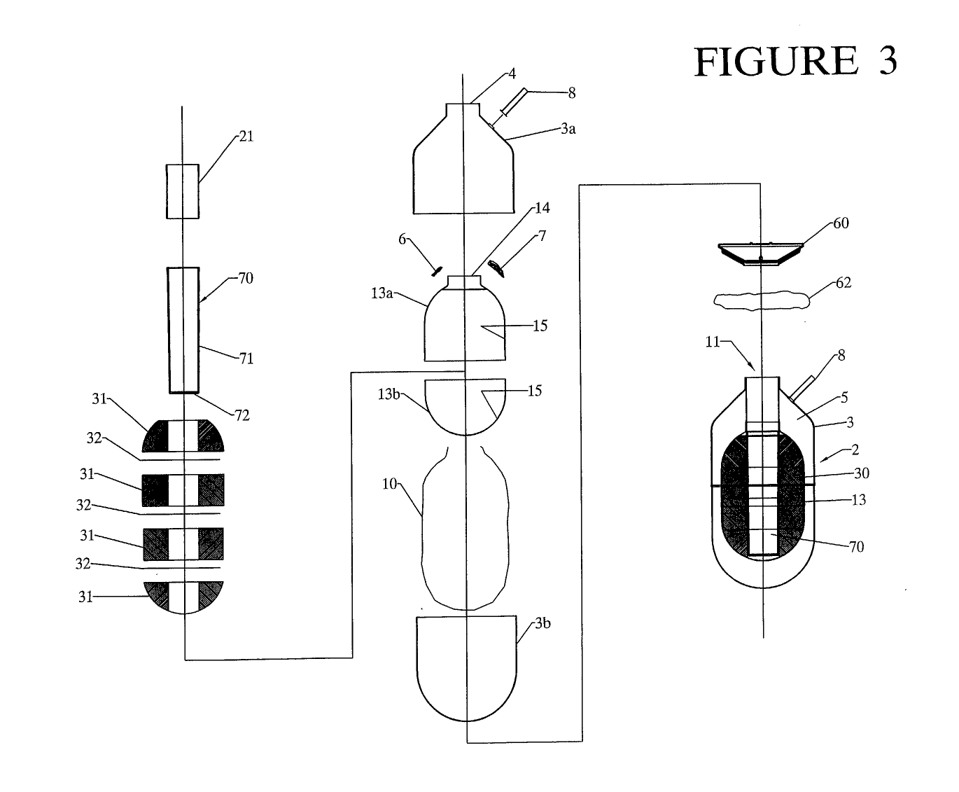

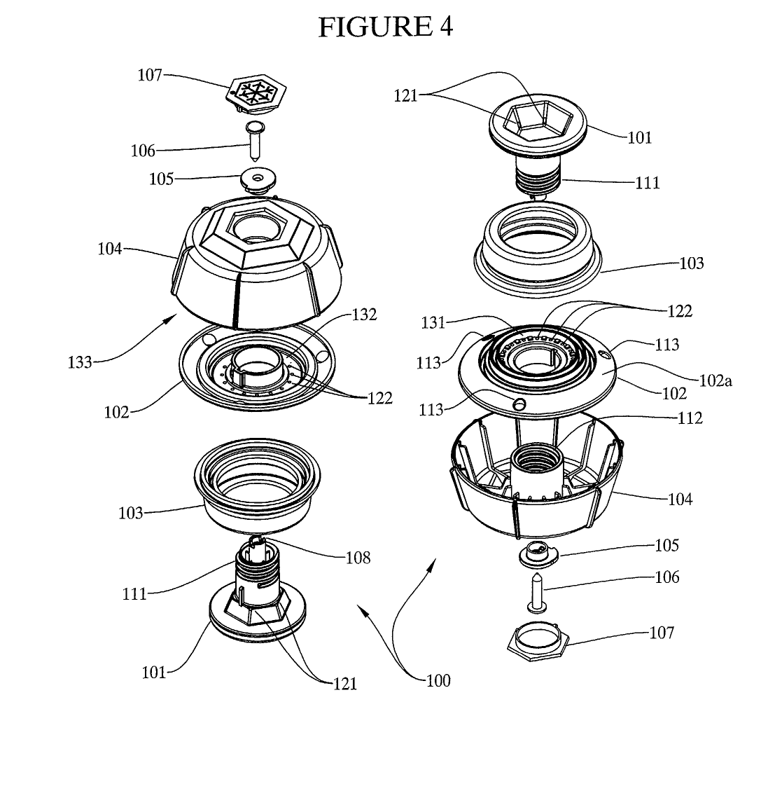

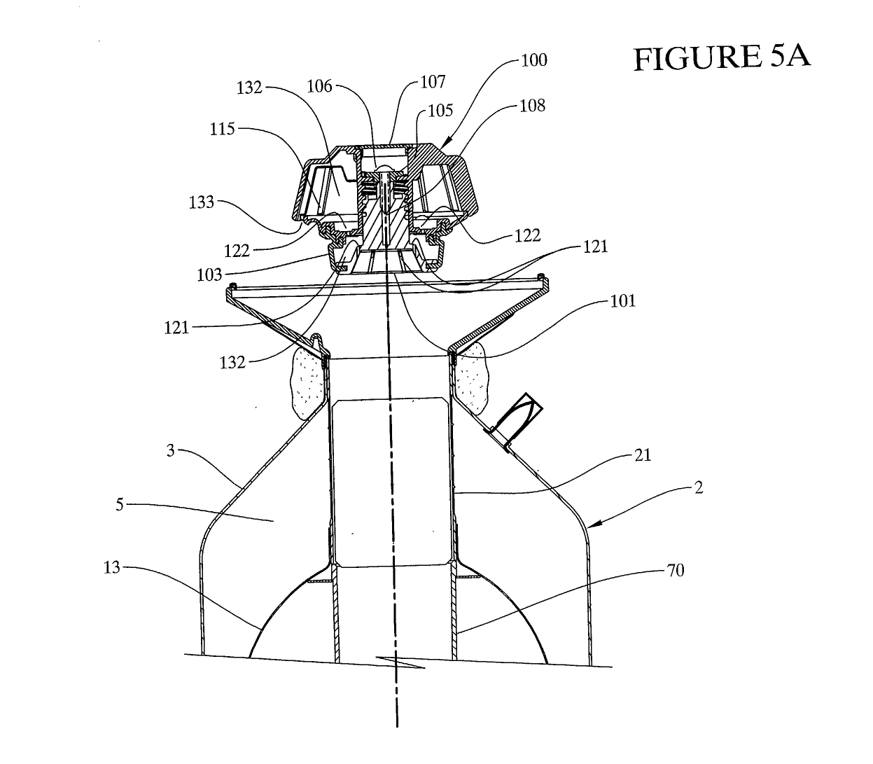

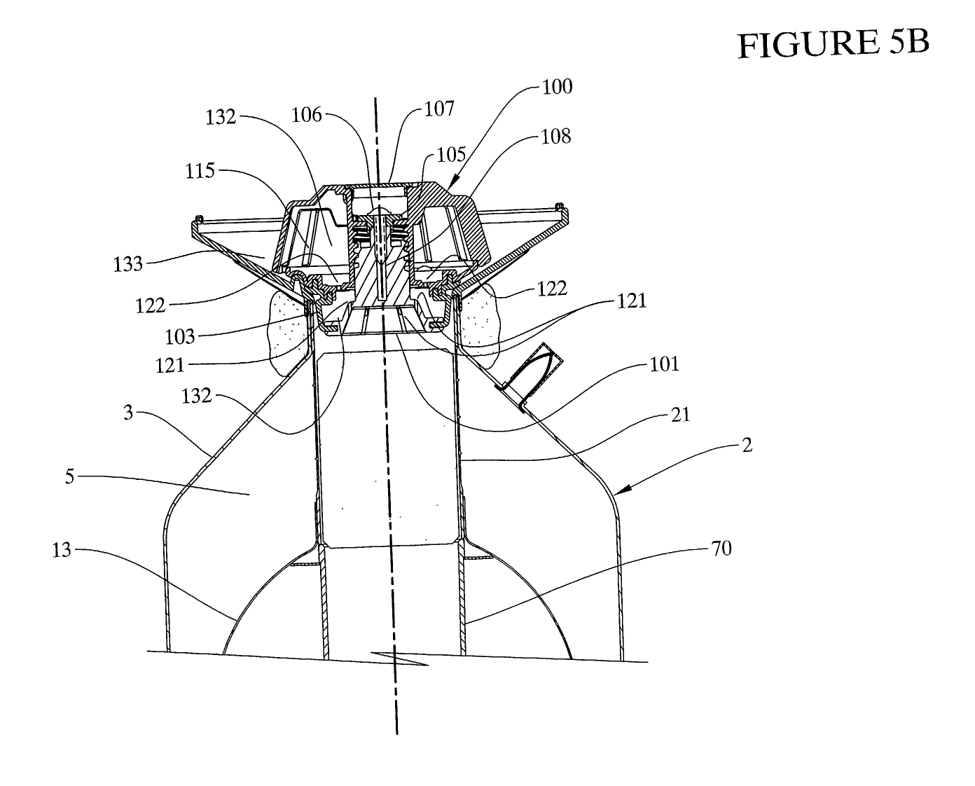

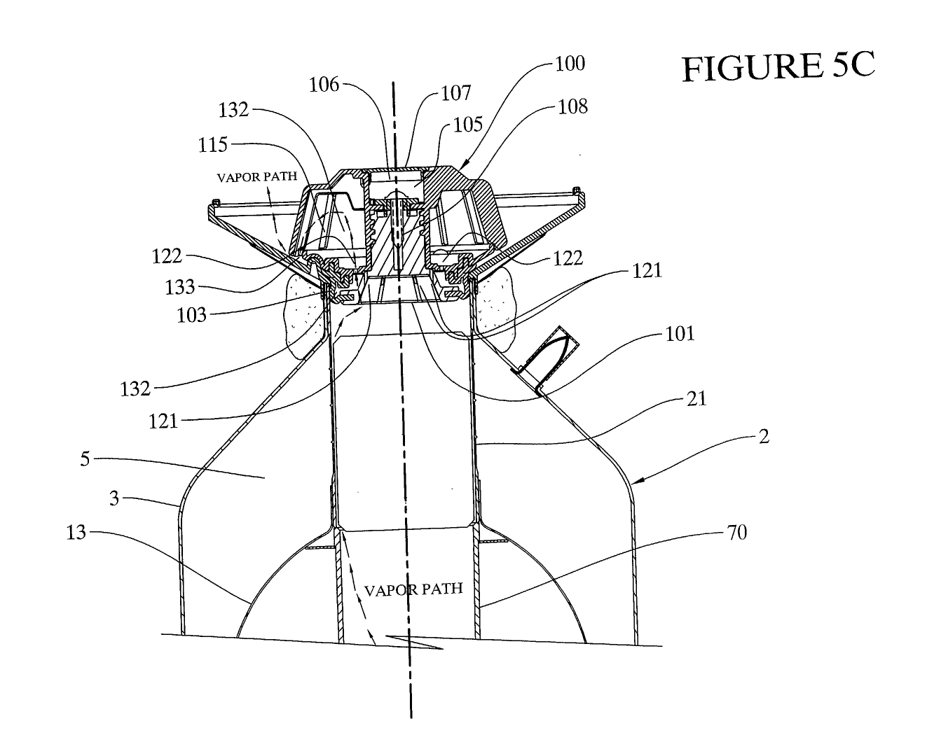

FIG. 1 provides an assembly drawing that illustrates all of the components of the cryogenic shipping container, generally designated as 1, in a disassembled state, and FIG. 2 illustrates how all of these components fit together in an assembled state. FIG. 3 is an assembly drawing that illustrates how dewar vessel 2 is assembled. FIGS. 4 and 5 illustrate an especially preferred self-venting cap useful with a dewar vessel. All of these Figures, as well as the assembly of parts illustrated in these Figures, are described in detail in a patent application filed concurrently herewith, Attorney Docket No. JSF35.051, entitled “CRYOGENIC SHIPPING CONTAINER, the disclosure of which is specifically incorporated herein by reference. However, it is worth repeating, for the sake of clarity herein, that a dewar vessel has an outer casing and an inner vessel with each having openings at their tops connected together by a neck portion forming an evacuable space between the outer casing and the inner vessel and a dewar opening into the inner vessel.

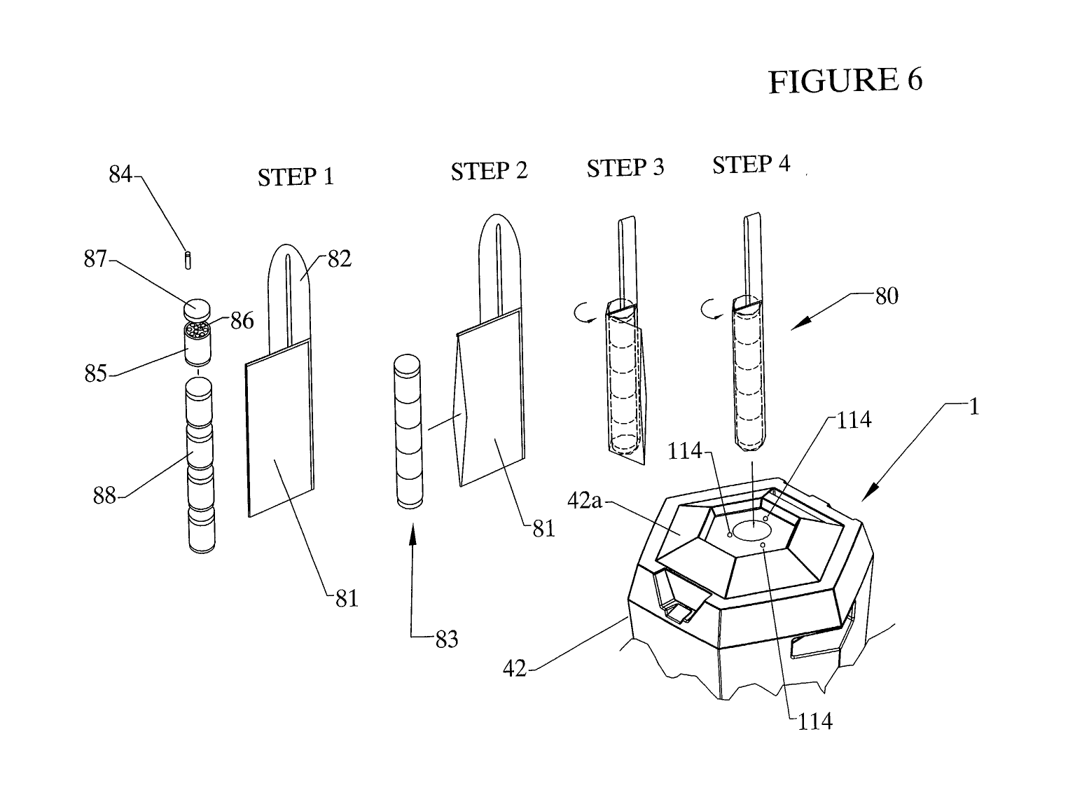

FIG. 6 illustrates a containment system that is especially useful for dangerous materials (such as potentially biohazardous or infectious agents) that is designed and constructed to withstand the standards of UN Class 6.2 certification. When this containment system is used with self-venting cap 100 illustrated in FIG. 4 in an especially preferred shipping container as illustrated in FIGS. 1 and 2, the result is an economical and superior shipping container that meets rigid shipping regulations concerning shipment of dangerous (infective) materials.

Containment system 80 is based upon a primary porous structural cartridge 83 and a bag 81. As shown in steps 1 through 4 of FIG. 4, structural cartridge 83 is placed into bag 81, bag 81 is sealed to complete containment system 80, and then containment system 80 can be lowered into specimen chamber 70 through dewar opening 11 by bag handle 82. Handle 82 can be made from a loop of the polymer film used to make bag 81.

Bag 81 is made of a cryogenically compatible polymer film with a sealing mechanism that assures a liquid and vapor tight seal when actuated. A fluorinated ethylene propylene resin or a polyimide film have been found suitable for this purpose, and Teflon® FEP Grade 160 or Kapton® FN film are especially preferred. Teflon® FEP is a fluorinated ethylene propylene resin that meets American Society for Testing and Materials (“ASTM”) Standard Specification D2116-97 for FEP-Fluorocarbon Molding and Extrusion Materials. Kapton® FN is a high-quality plastic film commercially available from DuPont. It is believed that Tyvek® spunbonded olefin, and in particular DuPont® Medical grade Tyvek® types S-1059-B and S-1073B, are also suitable for use as bag 81. The sealing mechanism should create a seal that prevents liquid or vapor from entering or leaving the interior of bag 81. The sealing mechanism can be a mechanical closure (in which case it is especially preferred that it be constructed of two materials with dissimilar coefficients of thermal expansion), an adhesive joint, or a heat seal.

It is especially preferred that structural cartridge 83 contain more than one cartridge. Each cartridge has a plurality of sample apertures to hold a plurality of sample receptacles separate from one another. The top cartridge of structural cartridge 83 has a base 85 and a cover 87 that mates with cartridge base 85 to enclose the plurality of sample receptacle apertures 86 and any sample receptacles 84 (vials) held within said plurality of sample receptacle apertures. The bottom of cartridge base 85 is designed so that it can function as a cover 87 to mate with an additional cartridge base 88. Stacking additional cartridge bases in the same fashion increases the size of cartridge 83. The components of structural cartridge 83 (i.e., cover 87, base 85 and any additional bases 88) are made of a polypropylene polymer compound. Each cartridge has sufficient absorbing capacity to absorb the entire contents of the plurality of sample receptacles held within the plurality of sample receptacle apertures. It is especially preferred that each cartridge have sufficient absorbing capacity to absorb twice the entire contents of all of the plurality of sample receptacles held within the plurality of sample receptacle apertures.

Structural cartridge 83 performs two essential requirements of the Dangerous Goods Regulations. The first requirement, separation of the primary receptacles, is required by IATA Packing Instruction 602 which states “[m]ultiple primary receptacles placed in a single secondary packaging must be wrapped individually or for infectious substances transported in liquid nitrogen, separated and supported to ensure that contact between them is prevented.” Cartridge 83 clearly meets this requirement and is an advance over current practices in the art in which it is common just to wrap receptacles loosely in sheets of absorbent cloth. The second requirement, found in IATA 602, states “[t]he absorbing material, for example cotton wool, must be sufficient to absorb the entire contents of all primary receptacles.” Again, cartridge 83 does this, with additional safety, and represents a significant advance in the current state of the art.

Accordingly, it will be apparent to those skilled in the art that still further changes and modifications in the actual concepts described herein can readily be made without departing from the spirit and scope of the disclosed inventions as defined by the following claims.

What is claimed is:

1. A containment system for samples of dangerous goods stored at cryogenic temperatures, comprising:
a bag made of a cryogenically compatible polymer film with a sealing mechanism that will seal the bag when it is actuated;
a porous structural cartridge for holding a plurality of sample receptacles separate from one another, comprising:
a cartridge base with a plurality of sample receptacle apertures for holding the plurality of sample receptacles; and
a cartridge cover that mates with the cartridge base to enclose the plurality of sample receptacle apertures and any sample receptacles held within said plurality of sample receptacle apertures.

2. A containment system as recited in claim 1, wherein the polymer film is selected from the group consisting of Teflon® FEP and Kapton® polyimide film.

3. A containment system as recited in claim 1, wherein the polymer film is a fluorinated ethylene propylene resin.

4. A containment system as recited in claim 3, wherein the polymer film meets American Society for Testing and Materials Standard Specification D2116-97 for FEP-Fluorocarbon Molding and Extrusion Materials.

5. A containment system as recited in claim 1, wherein the polymer film is comprised of a polyimide film.

6. A containment system as recited in claim 1, wherein the sealing mechanism is a mechanical closure.

7. A containment system as recited in claim 6, wherein the mechanical closure is constructed of two materials with dissimilar coefficients of thermal expansion.

8. A containment system as recited in claim 1, wherein the sealing mechanism is an adhesive joint.

9. A containment system as recited in claim 1, wherein the sealing mechanism is a heat seal.

10. A containment system as recited in claim 1, wherein the structural cartridge is made of a polypropylene polymer compound.

11. A containment system as recited in claim 1, wherein the structural cartridge has sufficient absorbing capacity to absorb the entire contents of all of the plurality of sample receptacles held within the plurality of sample receptacle apertures.

12. A containment system as recited in claim 1, wherein the bag has a handle useful for lowering the system into a specimen chamber of a dewar vessel and for removing the system from the specimen chamber.

13. A containment system as recited in claim 1, wherein the handle is comprised of a loop of the polymer film.

14. A containment system as recited in claim 1, wherein the system is designed and constructed to withstand the standards of UN Class 6.2 certification.

15. A containment system as recited in claim 1, wherein the porous structural cartridge is further comprised of:
one or more additional cartridge bases, each such additional cartridge base having an additional plurality of sample receptacle apertures for holding an additional plurality of sample receptacles and adapted to matingly engage with a bottom of a separate cartridge base to enclose the additional plurality of sample receptacle apertures and any additional sample receptacles held within said plurality of additional sample receptacle apertures.

16. A containment system as recited in claim 15, wherein the cartridge base and the one or more additional cartridge base form a substantially cylindrical shape when stacked together and held within the bag once the sealing mechanism is actuated.

17. A containment system for samples of dangerous goods shipped in a specimen chamber of a portable, insulated shipping container for storing materials at cryogenic temperatures through the use of a liquid cryogen in a dewar vessel that meets the standards of UN Class 6.2 certification, comprising:
a sealed bag made of a cryogenically compatible polymer; and
a porous structural cartridge with a removable lid that encloses a plurality of sample receptacles held separate from one another in a plurality of sample receptacles, the porous structural cartridge being held within the sealed bag;
wherein the structural cartridge has sufficient absorbing capacity to absorb the entire contents of all of the plurality of sample receptacles held within the plurality of sample receptacle apertures.

18. A containment system as recited in claim 17, wherein the cryogenically compatible polymer is selected from the group consisting of a fluorinated ethylene propylene resin or a polyimide film.

19. A containment system as recited in claim 18, wherein the bag has a handle useful for lowering the system into a specimen chamber of a dewar vessel and for removing the system from the specimen chamber.

20. A containment system as recited in claim 19, further comprising:
an additional cartridge base that matingly engages with the structural cartridge which serves as an additional removable lid that encloses an additional plurality of sample receptacles held separate from one another in an additional plurality of sample receptacles apertures, the additional cartridge base having sufficient absorbing capacity to absorb the entire contents of all of the additional plurality of sample receptacles held within the additional plurality of sample receptacle apertures.

21. A dewar vessel assembly that includes a containment system for samples of dangerous goods that meets the standards of UN Class 6.2 certification in an insulated shipping container for storing materials at cryogenic temperatures through the use of a liquid cryogen, comprising:
a dewar vessel having an outer casing and an inner vessel with each having openings at their tops connected together by a neck portion forming an evacuable space between the outer casing and the inner vessel and a dewar opening into the inner vessel;
a specimen chamber held within the inner vessel that extends inside the inner vessel and is accessed through the dewar opening;
a sealed bag made of a cryogenically compatible polymer that is held within the specimen chamber;
a porous structural cartridge with a removable lid that encloses a plurality of sample receptacles held separate from one another in a plurality of sample receptacles, the porous structural cartridge being held within the sealed bag; and
a cryogenically compatible open cell plastic absorbent foam held within the inner vessel between an inner wall of the inner vessel and the specimen chamber;
wherein the specimen chamber is comprised of an open-celled porous thermoplastic material that is cryogenically compatible that acts as a filter to prevent particles or fragments of the absorbent foam from entering into the specimen chamber while allowing a liquid cryogen to pass through the specimen chamber into the absorbent foam and allowing the liquid cryogen in a vapor phase liquid state to pass from the absorbent foam into the specimen chamber;
wherein the structural cartridge has sufficient absorbing capacity to absorb the entire contents of all of the plurality of sample receptacles held within the plurality of sample receptacle apertures.
